(19) United States
(12) Patent Application Publication
(10) Pub. No.: US 2017/0232882 A1
(43) Pub. Date: Aug. 17, 2017

(54) VEHICLE LAMP

(71) Applicant: KOITO MANUFACTURING CO., LTD., Tokyo (JP)

(72) Inventor: Mitsuyuki Mochizuki, Shizuoka (JP)

(73) Assignee: KOITO MANUFACTURING CO., LTD., Tokyo (JP)

(21) Appl. No.: 15/435,359

(22) Filed: Feb. 17, 2017

(30) Foreign Application Priority Data
Feb. 17, 2016 (JP) 2016-028439

(51) Int. Cl. B60Q 1/12; F21S 8/10

(52) U.S. Cl. CPC B60Q 1/12; F21S 48/1305; F21S 48/115; F21S 48/1145; F21S 48/1104; F21Y 2115/30

(57) ABSTRACT

Each of a pair of (left and right) lamp modules is equipped with a first lamp unit having four first light sources and a second lamp unit having a single second light source, and a horizontally long first light distribution pattern or part of it is formed by selectively lighting one or more of the four first light sources. Furthermore, a second light distribution pattern that is smaller and brighter than the first light distribution pattern is formed by lighting the second light source. The first light distribution pattern and the second light distribution pattern are combined, whereby a high-luminous-intensity region is formed as an overlap of them. The first lamp unit and the second lamp unit are configured so as to be able to swing in a horizontal plane so that the high-luminous-intensity region can be shifted in the left-right direction according to a vehicle running situation.

### CROSS-REFERENCE TO RELATED APPLICATION

The present application claims the benefit of priority of Japanese Patent Application No. 2016-028439, filed on Feb. 17, 2016, the disclosure of which is incorporated herein by reference.

### TECHNICAL FIELD

The present invention relates to a vehicle lamp that is equipped with a lamp unit having a plurality of light sources.

### BACKGROUND ART

Vehicle lamps that are equipped with a lamp unit having a plurality of light sources are known. A lamp unit of such a vehicle lamp is disclosed in JP-A-2013-243080.

This lamp unit is configured so as to form a horizontally long light distribution pattern or part of it by selectively lighting one or more of the light sources.

By employing the vehicle lamp disclosed in Patent document 1, necessary forward visibility is secured for the driver of the self vehicle without causing the driver of an oncoming vehicle or a vehicle ahead to be dazzled by glare.

However, even where such a vehicle lamp is employed, to further improve the forward visibility of the driver of the self vehicle, a configuration is desired that can form a light distribution pattern that is brighter in its main region.

### SUMMARY OF THE INVENTION

The present invention has been made in view of the above circumstances, and an object of the present invention is therefore to provide a vehicle lamp that comprises a lamp unit having a plurality of light sources and can improve the forward visibility of the driver of the self vehicle without causing the driver of an oncoming vehicle or a vehicle ahead to be dazzled by glare.

The present invention provides a vehicle lamp comprising a first lamp unit having a plurality of first light sources, characterized in:

that the vehicle lamp further comprises a second lamp unit having a second light source;

that the first lamp unit is configured so as to form a horizontally long first light distribution pattern or part of it when one or more of the first light sources are lit selectively;

that the second lamp unit is configured so as to form a second light distribution pattern that is smaller and brighter than the first light distribution pattern when the second light source is lit; and

that at least the second lamp unit of the first lamp unit and the second lamp unit is configured so as to be able to swing in a horizontal plane.

The kind and the specific configuration of the first light sources and the second light source are not limited to particular ones.

The first light distribution pattern and the second light distribution pattern may be such as to be able to form a high-beam light distribution pattern when combined or such as to be able to form, when combined, an additional light distribution pattern that is added to a low beam light distribution pattern in forming a high-beam light distribution pattern.

There are no particular limitations on the positional relationship between the first lamp unit and the second lamp unit. For example, they may be disposed in two stages in the vertical direction or arranged side by side in the left-right direction.

In the vehicle lamp according to the present invention, a horizontally long first light distribution pattern or part of it is formed by selecting lighting one or more of the first light sources of the first lamp unit. This makes it possible to secure necessary forward visibility of the driver of the self vehicle without causing the driver of an oncoming vehicle or a vehicle ahead to be dazzled by glare.

A second light distribution pattern that is smaller and brighter than the first light distribution pattern is formed further by lighting the second light source of the second lamp unit. The first light distribution pattern and the second light distribution pattern are combined, whereby a high-luminous-intensity region is formed as an overlap of them.

Since at least the second lamp unit of the first lamp unit and the second lamp unit is configured so as to be able to swing in a horizontal plane, the high luminous-intensity region can be shifted in the left-right direction according to a vehicle running situation. This makes it possible to improve the forward visibility of the driver of the self vehicle without causing the driver of an oncoming vehicle or a vehicle ahead to be dazzled by glare.

As such, the present invention provide a vehicle lamp that is equipped with a lamp unit having a plurality of light sources and can improve the forward visibility of the driver of the self vehicle without causing the driver of an oncoming vehicle or a vehicle ahead to be dazzled by glare.

In the above configuration, the first light sources may be light-emitting diodes, in which case a horizontally long first light distribution pattern or part of it can be formed with high positional accuracy. The second light sources may be such as to use a laser diode, in which case a second light distribution pattern that is smaller and brighter than the first light distribution pattern can be formed easily.

In the above configuration, the first lamp unit and the second lamp unit may be configured so as to be able to swing together in a horizontal plane, in which case the high-luminous-intensity region can be shifted in the left-right direction according to a vehicle running situation while the positional relationship between the first light distribution pattern and the second light distribution pattern is kept constant.

The above configuration may be modified so that the first lamp unit further has a reflector which reflects, toward the front side of a vehicle, light beams emitted from the first light sources, and that the first light sources are arranged side by side in the vehicle width direction. In this case, a horizontally long first light distribution pattern or part of it can be formed by a simple configuration.

In the above configuration, two sets of a first lamp unit and a second lamp unit may be provided. In this case, since two sets of a first light distribution pattern and a second light distribution pattern can be formed. By combining these light distribution patterns, a control for improving the forward visibility of the driver of the self vehicle can be performed meticulously without causing the driver of an oncoming vehicle or a vehicle ahead to be dazzled by glare.

### BRIEF DESCRIPTION OF DRAWINGS

FIG. 1 is a front view of a vehicle lamp set according to a first embodiment of the present invention.

FIGS. 2A and 2B are sectional views taken along line IIa-IIa and line IIb-IIb in FIG. 1, respectively.

FIG. 3A is a see-through view showing a high-beam light distribution pattern that is formed by illumination light beams emitted from the vehicle lamp set shown in FIG. 1, and FIGS. 3B and 3C show left and right light distribution patterns of the high-beam light distribution pattern, respectively.

FIG. 4A is a see-through view showing a first example high-beam light distribution pattern that is formed by removing part of component light distribution patterns of the high-beam light distribution pattern shown in FIG. 3A, and FIGS. 4B and 4C show left and right light distribution patterns of the first example high-beam light distribution pattern, respectively.

FIG. 5A is a see-through view showing a second example high-beam light distribution pattern that is formed by removing part of the component light distribution patterns of the high-beam light distribution pattern shown in FIG. 3A, and FIGS. 5B and SC show left and right light distribution patterns of the second example high-beam light distribution pattern, respectively.

FIG. 6A is a see-through view showing a third example high-beam light distribution pattern that is formed by removing part of the component light distribution patterns of the high-beam light distribution pattern shown in FIG. 3A, and FIGS. 6B and 6C show left and right light distribution patterns of the third example high-beam light distribution pattern, respectively.

FIG. 7A is a see-through view showing a fourth example high-beam light distribution pattern that is formed by removing part of the component light distribution patterns of the high-beam light distribution pattern shown in FIG. 3A, and FIGS. 7B and 7C show left and right light distribution patterns of the fourth example high-beam light distribution pattern, respectively.

FIG. 8A is a see-through view showing a fifth example high-beam light distribution pattern that is formed by removing part of the component light distribution patterns of the high-beam light distribution pattern shown in FIG. 3A, and FIGS. 8B and 8C show left and right light distribution patterns of the fifth example high-beam light distribution pattern, respectively.

FIG. 9 is a front view of a vehicle lamp set according to a second embodiment of the present invention.

FIG. 10A is a see-through view showing a high-beam light distribution pattern that is formed by illumination light beams emitted from the vehicle lamp set shown in FIG. 9, and FIGS. 10B and 10C show left and right light distribution patterns of the high-beam light distribution pattern, respectively.

FIG. 11A is a see-through view showing a first example high-beam light distribution pattern that is formed by removing part of component light distribution patterns of the high-beam light distribution pattern shown in FIG. 10A, and FIGS. 11B and 11C show left and right light distribution patterns of the first example high-beam light distribution pattern, respectively.

FIG. 12A is a see-through view showing a second example high-beam light distribution pattern that is formed by removing part of the component light distribution patterns of the high-burn light distribution pattern shown in FIG. 10A, and FIGS. 12B and 12C show left and right light distribution patterns of the second example high-beam light distribution pattern, respectively.

FIG. 13A is a see-through view showing a first example modified high-beam light distribution pattern that is formed by illumination light beams emitted from the vehicle lamp set shown in FIG. 9, and FIGS. 13B and 13C show left and right light distribution patterns of the first example modified high-beam light distribution pattern, respectively.

FIG. 14A is a see-through view showing a second example modified high-beam light distribution pattern that is formed by illumination light beams emitted from the vehicle lamp set shown in FIG. 9, and FIGS. 14B and 14C show left and right light distribution patterns of the second example modified high-beam light distribution pattern, respectively.

FIG. 15A is a see-through view showing an example high-beam light distribution pattern that is formed by illumination light beams emitted from the vehicle lamp set shown in FIG. 9 by removing part of the component light distribution patterns, and FIGS. 15B and 15C show left and right light distribution patterns of the example high-beam light distribution pattern, respectively.

### DETAILED DESCRIPTION

Embodiments of the present invention are hereinafter described with reference to the drawings.

A first embodiment of the present invention is hereinafter described.

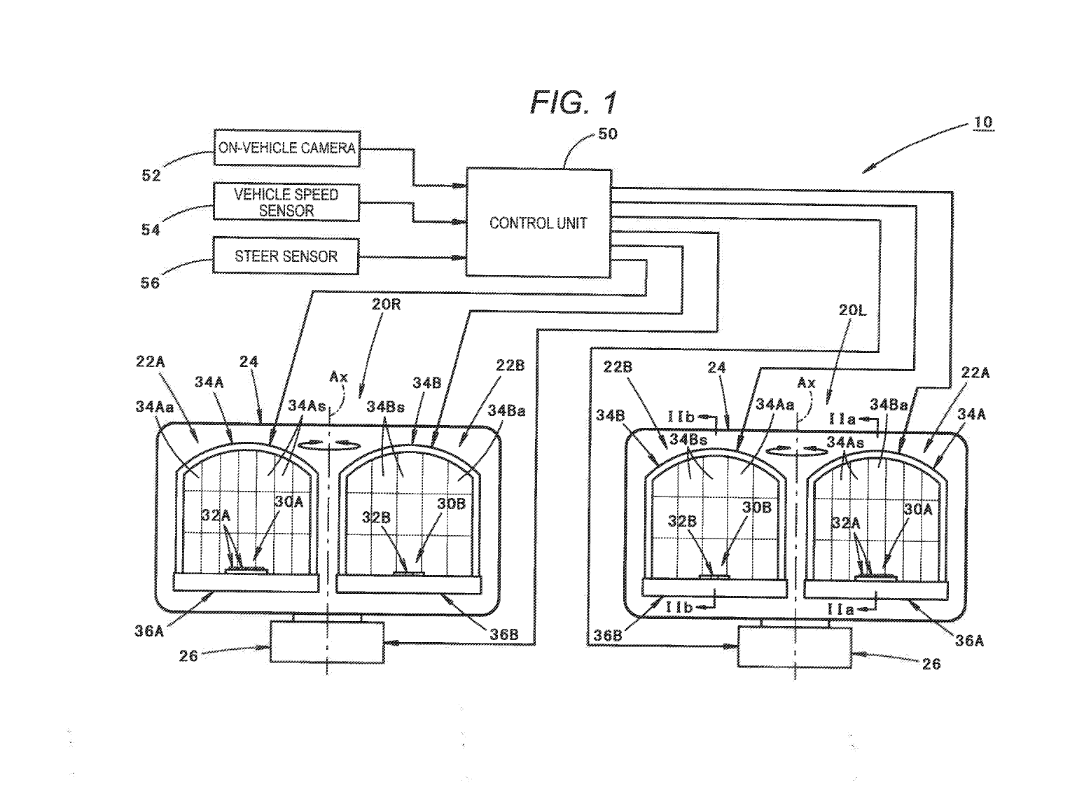

FIG. 1 is a front view of a vehicle lamp set 10 according to the first embodiment.

As shown in FIG. 1, the vehicle lamp set 10 is equipped with a pair of (left and right) lamp modules 20L and 20R, a control unit 50, an on-vehicle camera 52 for shooting a scene ahead of the vehicle, a vehicle speed sensor 54, and a steer angle sensor 56,

The pair of lamp modules 20L and 20R are disposed at the front-left and front-right corners of a vehicle and are configured so as to be left-right symmetrical with each other. Each of the lamp modules 20L and 20R is housed in a lamp room that is formed by a lamp body and a transparent cover (neither is shown).

Each of the lamp modules 20L and 20R is equipped with a first lamp unit 22A and a second lamp unit 22B which are arranged side by side in the left-right direction, a support frame 24 which supports them, a swing mechanism 26 for swinging the first lamp unit 22A and the second lamp unit 22B about a vertical axis Ax together with the support frame 24.

A signal of image data taken by the on-vehicle camera 52, a vehicle speed signal generated by the vehicle speed sensor 54, and a steer angle signal generated by the steer angle sensor 56 are input to the control unit 50. On the basis of these input signals, the control unit 50 performs drive controls on the swing mechanisms 26 individually and performs turning on/off controls on the first lamp units 22A and the second lamp units 22B of the lamp modules 20L and 20R individually.

Since as described above the pair of lamp modules 20L and 20R are left-right symmetrical with each other, the configurations of the first lamp unit 22A and the second lamp unit 22B of the left (right when viewed from the front side) lamp module 20L will be described below.

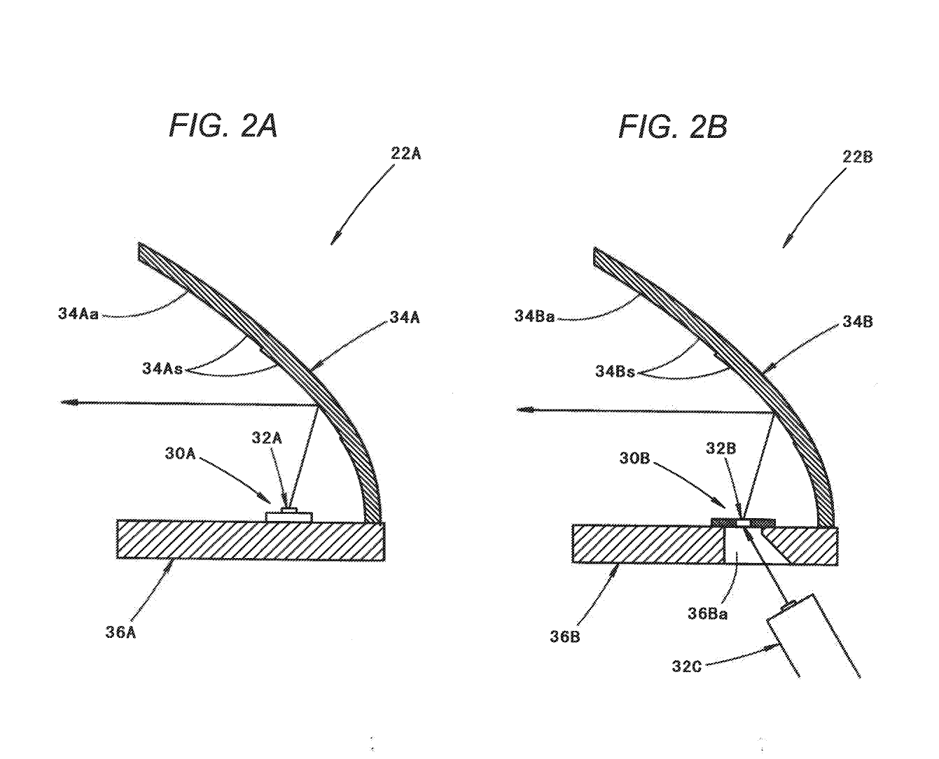

FIGS. 2A and 2B are sectional views taken along line IIa-IIa and line IIb-IIb in FIG. 1, respectively.

As seen from these figures, the first lamp unit 22A and the second lamp unit 22B are parabolic lamp units.

The first lamp unit 22A is equipped with a light source unit 30A having four first light sources 32A, a reflector 34A for reflecting exit light of the light source unit 30A forward, and a base member 36A which supports the light source unit 30A and the reflector 34A.

In the first lamp unit 22A, the first light sources 32A of the light source unit 30A are white light-emitting diodes. That is, the four first light sources 32A each of which is a light-emitting chip of a white light-emitting diode are arranged side by side in the vehicle width direction with their light emission surfaces up.

The reflector 34A is disposed so as to cover the light source unit 30A from above. A reflection surface 34Aa of the reflector 34A is formed by a plurality of reflection elements 34As which reflect, in a controlled manner, light coming from each of the four first light sources 32A.

The base member 36A is a plate-like member and extends in a horizontal plane.

On the other hand, the second lamp unit 22B is equipped with a light source unit 30B having a single second light source 32B, a reflector 34B for reflecting exit light of the second light source 32B outward, and a base member 36B which supports the light source unit 30B and the reflector 34B.

In the second lamp unit 22B, a laser diode 32C is used for the second light source 32B of the light source unit 30B. That is, the second light source 32B is a phosphor that emits white light when irradiated with laser light emitted from the laser diode 32C. The second light source 32B is disposed in such a manner that its light emission surface is directed upward.

The reflector 34B is disposed so as to cover the second light source 32B from above. A reflection surface 34Ba of the reflector 34B is formed by a plurality of reflection elements 34Bs which reflect, in a controlled manner, light coming from the second light source 32B.

The base member 36B is a plate-like member and extends in a horizontal plane. The base member 36B is formed with an opening 36Ba through which laser light emitted from the laser diode 32C passes to irradiate the second light source 32B.

Each of the lamp modules 20L and 20R is configured so that the four first light sources 32A are turned on or off together or a selected part of them are turned on or off under a drive control of the control unit 50. The second light source 32B is configured so as to be turned on or off with proper timing.

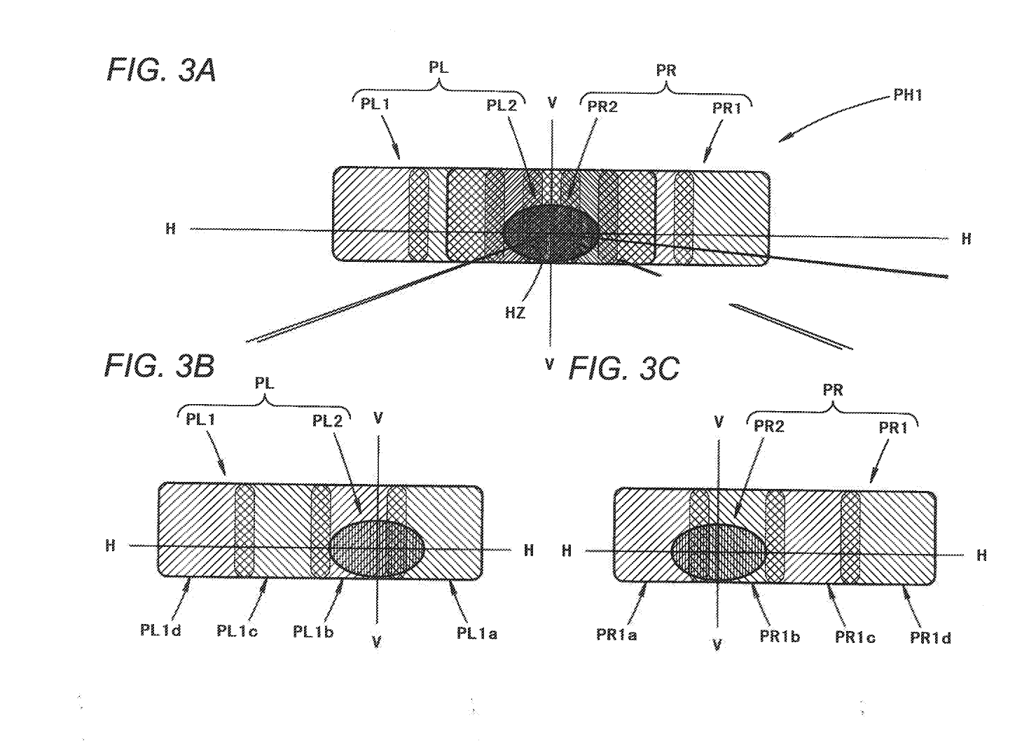

FIG. 3A is a see-through view showing a high-beam light distribution pattern PH1 which is formed by illumination light emitted from the vehicle lamp set 10 according to the embodiment on a virtual vertical screen located 25 m ahead of the vehicle.

The high-beam light distribution pattern PH1 is a light distribution pattern that is formed in a state that the lamp modules 20L and 20R are directed directly forward (i.e., the swing mechanisms 26 are not being driven; hereinafter referred to as a reference state) and all of the first lamp units 22A and the second lamp units 22B of the lamp modules 20L and 20R are lit.

The high-beam light distribution pattern PH1 is a composite light distribution pattern of a light distribution pattern PL shown in FIG. 3B and a light distribution pattern PR shown in FIG. 3C.

The light distribution pattern PL shown in FIG. 3B is a light distribution pattern that is formed by illumination light emitted from the left lamp module 20L, and is a composite light distribution pattern of a first light distribution pattern PL1 which is formed by illumination light emitted from the first lamp unit 22A and a second light distribution pattern PL2 which is formed by illumination light emitted from the second lamp unit 22B.

The first light distribution pattern PL1 is a horizontally long light distribution pattern that is relatively short on the right side of a vertical line V-V that intersects a vanishing point H-V located ahead of the vehicle lamp set 10, and is relatively long on the left side of the vertical line V-V. In the vertical direction, the first light distribution pattern PL1 is wider above a horizontal line H-H that intersects the point H-V than below the horizontal line H-H.

The first light distribution pattern PL1 is a light distribution pattern that is formed when the four first light sources 32A of the light source unit 30A are lit simultaneously, and hence is composed of four light distribution patterns PL1a, PL1b, PL1c, and PL1d.

The four light distribution patterns PL1a, PL1b, PL1c, and PL1d have approximately rectangular outlines and are approximately the same in size. Adjoining ones of the light distribution patterns PL1a, PL1b, PL1c, and PL1d overlap with each other in the left-right direction, and the vertical line V-V intersects the second-right light distribution pattern PL1b at a position that is a little closer to its right edge than its left edge.

The second light distribution pattern PL2 is a light distribution pattern that is smaller and brighter than the first light distribution pattern PL1, and is a spot-shaped light distribution pattern that is a little longer in the horizontal direction than in the vertical direction and is centered at the point H-V. The horizontal width of the second light distribution pattern PL2 is set approximately the same as or a little greater than that of each of the light distribution patterns PL1a-PL1d.

Since the laser diode 32C is used for the second light source 32B of the second lamp unit 22B, the second light distribution pattern PL2 is a very bright light distribution pattern.

The light distribution pattern PR shown in FIG. 3C is a light distribution pattern that is formed by illumination light emitted from the right lamp module 20R, and is a composite light distribution pattern of a first light distribution pattern PR1 which is formed by illumination light emitted from the first lamp unit 22A and a second light distribution pattern PR2 which is formed by illumination light emitted from the second lamp unit 22B.

The first light distribution pattern PR1 is left-right symmetrical with the first light distribution pattern PL1 with respect to the vertical line V-V and in shape and luminous intensity distribution. That is, the first light distribution pattern PR1 is composed of four light distribution patterns PR1a, PR1b, PR1c, and PR1d which are left-right symmetrical with the four light distribution patterns PL1a, PL1b, PL1c, and PL1d, respectively, with respect to the vertical line V-V.

The second light distribution pattern PR2 is left-right symmetrical with the second light distribution pattern PL2 with respect to the vertical line V-V in shape and luminous intensity distribution.

As shown in FIG. 3A, the high-beam light distribution pattern PH1, which is formed in such a manner that the pair of (left and right) light distribution patterns PL and PR overlap with each other, is, as a whole, a horizontally long light distribution pattern that extends leftward and rightward from the vertical line V-V.

Whereas the high-beam light distribution pattern PH1 is wider above a horizontal line H-H than below the horizontal line H-H, its high-luminous-intensity region HZ which is centered at the point H-V is very high in luminous intensity. This is because the pair of (left and right) second light distribution patterns PL2 and PR2 which are small and bright and occupy the same region around the point H-V.

By virtue of the formation of the above-described high-beam light distribution pattern PH1, the forward visibility of the driver of the self vehicle is made sufficiently high when, for example, the vehicle is running straightly at high speed.

Furthermore, by shifting the high-beam light distribution pattern PH1 leftward or rightward according to a vehicle running situation, the forward visibility of the driver of the self vehicle is made sufficiently high even when, for example, the vehicle is running along a curved road.

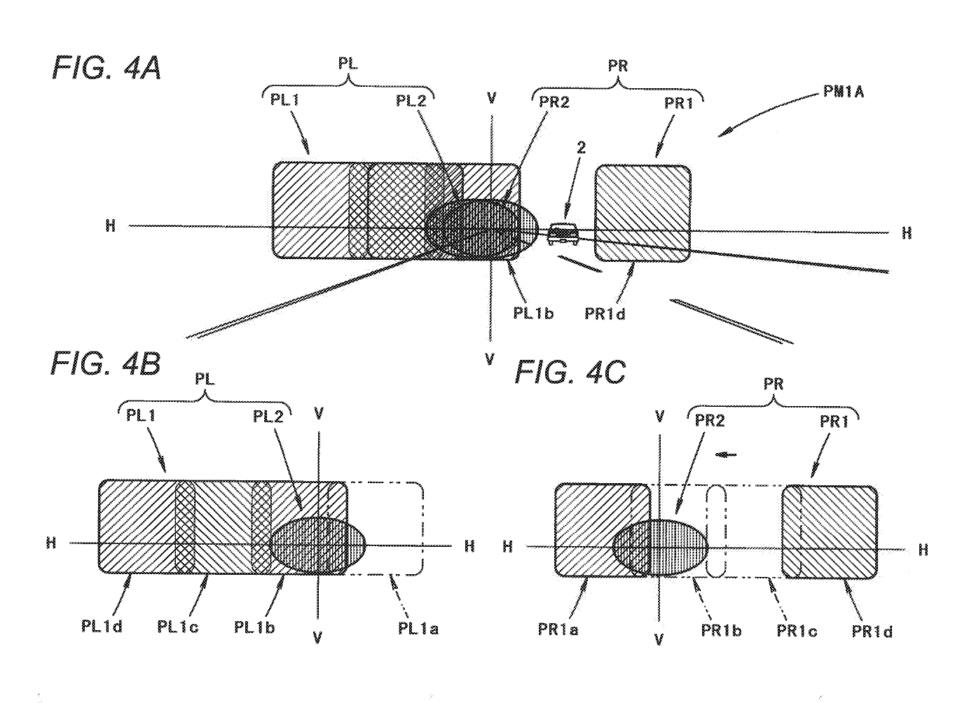

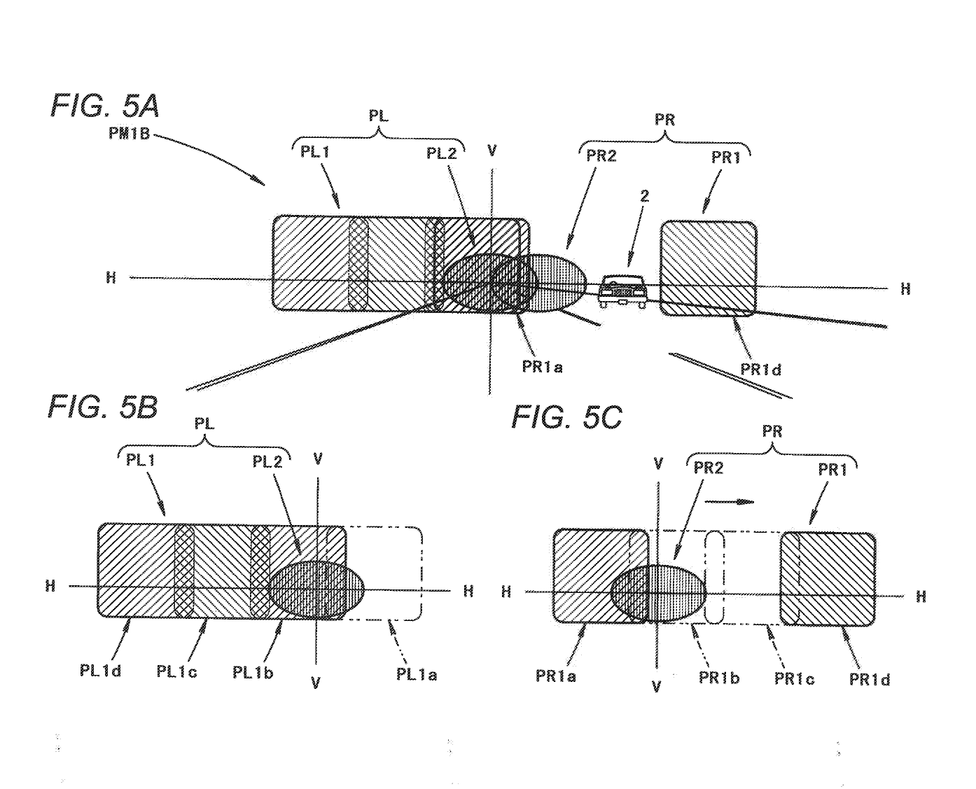

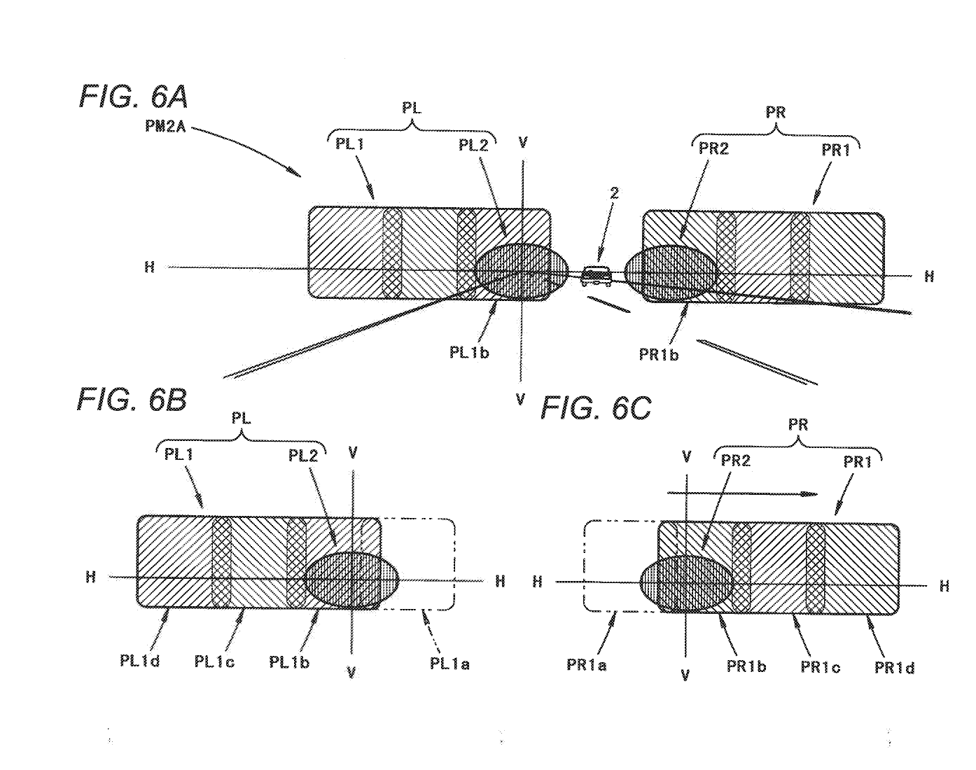

FIGS. 4A-4C to FIGS. 8A-8C show light distribution patterns each of which lacks part of the component light distribution patterns of the high-beam light distribution pattern PH1. FIGS. 4A-4C and FIGS. 5A-5C show light distribution patterns that are formed by examples of a first light distribution control. FIGS. 6A-6C to FIGS. 8A-8C show light distribution patterns that are formed by examples of a second light distribution control.

First, a description will be made of light distribution patterns formed by the first light distribution control.

FIG. 4A shows a light distribution pattern PM1A which is different from the high-beam light distribution pattern PH1 shown in FIG. 3A in that the former lacks part of the first light distribution pattern PL1 of the complete left light distribution pattern PL and part of the first light distribution pattern PR1 of the complete right light distribution pattern PR, and that in the former the right light distribution pattern PR is shifted leftward a little from its position in the reference state.

More specifically, the left light distribution pattern PL shown in FIG. 4B lacks the rightmost light distribution pattern PL1a of the four light distribution patterns PL1a-PL1d constituting the complete first light distribution pattern PL1. In this left light distribution pattern PL, a right end portion of the second light distribution pattern PL2 projects rightward from the right edge of the light distribution pattern PL1b.

On the other hand, the right light distribution pattern PR shown in FIG. 4C lacks the second-left light distribution pattern PR1b and the third-left light distribution pattern PR1c of the four light distribution patterns PR1a-PR1d constituting the complete first light distribution pattern PR1. In this right light distribution pattern PR, more than the right half of the second light distribution pattern PR2 projects rightward from the right edge of the light distribution pattern PR1a.

As shown in FIG. 4A, in the light distribution pattern PM1A, the light distribution pattern PR1d is placed in the vicinity of a relatively distant oncoming vehicle 2 by shifting the right light distribution pattern PR leftward a little from its position in the reference state.

As described above, since the light distribution pattern PM1A is such that the second light distribution pattern PL2 of the left light distribution pattern PL and the light distribution pattern PR1d of the right light distribution pattern PR are located on the left of and on the right of the oncoming vehicle 2, respectively, necessary visibility can be secured for the road ahead without causing the driver of the oncoming vehicle 2 to be dazzled by glare.

Furthermore, in the light distribution pattern PM1A, the second light distribution pattern PL2 and the light distribution pattern PL1b of the left light distribution pattern PL and the second light distribution pattern PR2 of the right light distribution pattern PR have an overlap around the point H-V, whereby a distant road region ahead can be illuminated brightly.

The position of the oncoming vehicle 2 is detected by the control unit 50's calculating a width, a center position, etc. of the oncoming vehicle 2 on the basis of image data of the oncoming vehicle 2 that is input from the on-vehicle camera 52. The control unit 50 shifts the right light distribution pattern PR leftward or rightward by driving the swing mechanism 26 of the lamp module 20R.

A light distribution pattern PM1B shown in FIG. 5A is different from the light distribution pattern PM1A shown in FIG. 4A in that the right light distribution pattern PR of the former is deviated rightward to a certain extent from its position in reference state (see FIG. 5C).

With this light distribution pattern PM1B in which the second light distribution pattern PR2 and the light distribution pattern PR1d of the right light distribution pattern PR are located on the left of and on the right of the oncoming vehicle 2, respectively, even when the oncoming vehicle 2 comes even closer to the self vehicle, necessary visibility can be secured for the road ahead without causing the driver of the oncoming vehicle 2 to be dazzled by glare.

Furthermore, in the light distribution pattern PM1B, the second light distribution pattern PL2 and the light distribution pattern PL1b of the left light distribution pattern PL and the second light distribution pattern PR1a of the right light distribution pattern PR have an overlap around the point H-V.

The second light distribution pattern PR2 of the right light distribution pattern PR is located immediately on the right of these light distribution patterns, whereby a distant road region ahead can be illuminated brightly.

Next, a description will be made of light distribution patterns formed by the second light distribution control.

FIG. 6A shows a light distribution pattern PM2A which is different from the high-beam light distribution pattern PH1 shown in FIG. 3A in that the former lacks part of the first light distribution pattern PL1 of the complete left light distribution pattern PL and part of the first light distribution pattern PR1 of the complete right light distribution pattern PR, and that in the former the right light distribution pattern PR is shifted rightward to a large extent from its position in the reference state.

More specifically, the left light distribution pattern PL shown in FIG. 6B lacks the rightmost light distribution pattern PL1a of the four light distribution patterns PL1a-PL1d constituting the complete first light distribution pattern PL1. On the other hand, the right light distribution pattern PR shown in FIG. 6C lacks the leftmost light distribution pattern PR1a of the four light distribution patterns PR1a-PR1d constituting the complete first light distribution pattern PR1.

In the light distribution pattern PM2A, the second light distribution patterns PL2 and PR2 are located on the left of and on the right of a relatively distant oncoming vehicle 2, respectively, by shifting the right light distribution pattern PR rightward to a large extent from its position in the reference state.

With this light distribution pattern PM2A, necessary visibility can be secured for the road ahead by the second light distribution patterns PL2 and PR2 located on the left of and on the right of the oncoming vehicle 2 without causing the driver of the oncoming vehicle 2 to be dazzled by glare.

Furthermore, in the light distribution pattern PM2A, the second light distribution pattern PL2 and the light distribution pattern PL1b of the left light distribution pattern PL have an overlap around the point H-V, whereby a distant road region ahead can be illuminated brightly.

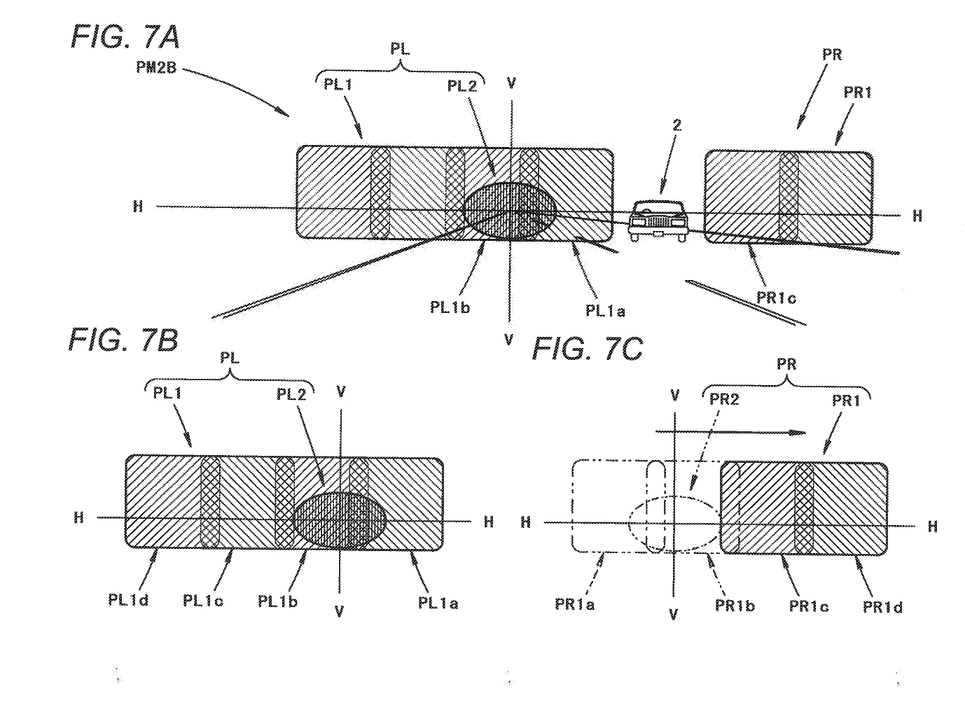

A light distribution pattern PM2B shown in FIG. 7A is different from the light distribution pattern PM2A shown in FIG. 6A in that the former further lacks the second-left light distribution pattern PR1b of the first light distribution pattern PR1 and the second light distribution pattern PR2 of the right light distribution pattern PR, and that in the former the rightmost light distribution pattern PL1a of the left light distribution pattern PL is restored (see FIGS. 7B and 7C).

With this light distribution pattern PM2B, even when the oncoming vehicle 2 comes even closer to the self vehicle, necessary visibility can be secured for the road ahead by the light distribution pattern PL1a of the first light distribution pattern PL1 and the light distribution pattern PR1c of the first light distribution pattern PR1 that are located on the left of and on the right of the oncoming vehicle 1, respectively, without causing the driver of the oncoming vehicle 2 to be dazzled by glare.

Furthermore, in the light distribution pattern PM2B, the second light distribution pattern PL2 and the light distribution pattern PL1b of the left light distribution pattern PL have an overlap around the point H-V, whereby a distant road region ahead can be illuminated brightly.

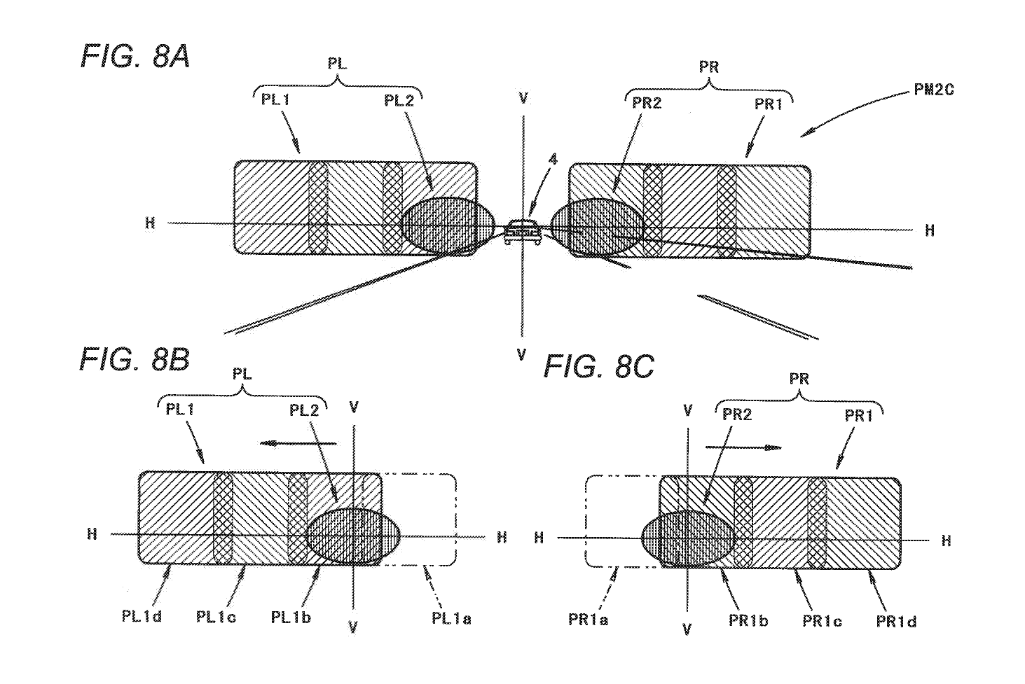

FIG. 8A shows a light distribution pattern PM3A which is different from the high-beam light distribution pattern PH1 shown in FIG. 3A in that the former lacks part of the first light distribution pattern PL1 of the complete left light distribution pattern PL and part of the first light distribution pattern PR1 of the complete right light distribution pattern PR, and that the left light distribution pattern PL and the right light distribution pattern PR are shifted from their positions in the reference state in such directions as to go away from each other.

More specifically, the left light distribution pattern PL shown in FIG. 8B lacks the rightmost light distribution pattern PL1a of the four light distribution patterns PL1a-PL1d constituting the complete first light distribution pattern PL1. On the other hand, the right light distribution pattern PR shown in FIG. 8C lacks the leftmost light distribution pattern PR1a of the four light distribution patterns PR1a-PR1d constituting the complete first light distribution pattern PR1.

In the light distribution pattern PM2C, the second light distribution patterns PL2 and PR2 are located on the left of and on the right of a vehicle 4 ahead, respectively, by shifting the left light distribution pattern PL leftward to a certain extent from its position in the reference state and shifting the right light distribution pattern PR rightward by the same distance as the left light distribution pattern PL is from its position in the reference state.

With this light distribution pattern PM2C, necessary visibility can be secured for the road ahead without causing the driver of the vehicle 4 ahead to be dazzled by glare.

Furthermore, in the light distribution pattern PM2C, the second light distribution patterns PL2 and PR2 that are located on the left of and on the right of the vehicle 4 ahead, respectively, are relatively close to the vertical line V-V, whereby a distant road region ahead can be illuminated brightly.

It is noted that by varying the interval between the left and right light distribution patterns PL and PR according to the distance between the self vehicle and a vehicle 4 ahead, the forward visibility of the driver of the self vehicle can be maximized without causing the driver of the vehicle 4 ahead to be dazzled by glare.

Next, workings and advantages of the embodiment will be described.

Equipped with the pair of lamp modules 20L and 20R for forming a pair of (left and right) light distribution patterns PL and PR, the vehicle lamp set 10 according to the embodiment can form the high-beam light distribution pattern PHI in the form of a composite light distribution pattern of the pair of (left and right) light distribution patterns PL and PR.

Each of the lamp modules 20L and 20R is equipped with the first lamp unit 22A having the four first light sources 32A and the second lamp unit 22B having the single second light source 32B. A horizontally long complete first light distribution pattern PL1 or PR1 or part of it is formed by selectively lighting one or more of the four first light sources 32A of each first lamp unit 22A. As a result, necessary forward visibility of the driver of the self vehicle can be secured without causing the driver of an oncoming vehicle or a vehicle ahead to be dazzled by glare.

The second light source 32B of the second lamp unit 22B of each of the lamp modules 20L and 20R is lit further to form a second light distribution pattern PL2 or PR2 that is smaller and brighter than the first light distribution pattern PL1 or PR1. A high-luminous-intensity region HZ can be formed as an overlap of the first light distribution pattern PL1 or PR1 and the second light distribution pattern PL2 or PR2.

Furthermore, each of the lamp modules 20L and 20R is configured in such a manner that the first lamp unit 22A and the second lamp unit 22B can be swung in a horizontal plane, the high-luminous-intensity region HZ can be shifted in the left-right direction according to a vehicle running state, whereby the forward visibility of the driver of the self vehicle can be improved without causing the driver of an oncoming vehicle or a vehicle ahead to be dazzled by glare.

Thus, the vehicle lamp set 10 according to the embodiment which is equipped with the first lamp units 22A each having the four first light sources 32A can improve the forward visibility of the driver of the self vehicle without causing the driver of an oncoming vehicle or a vehicle ahead to be dazzled by glare.

Still further, according to the embodiment, since the first light sources 32A of each first lamp unit 22A are light-emitting diodes, a horizontally long complete first light distribution pattern PL1 or PR1 or part of it can be formed with high positional accuracy. Since the laser diode 32C is used for each second light source 32B, a second light distribution pattern PL2 or PR2 that is smaller and brighter than the first light distribution pattern PL1 or PR1 can be formed easily.

According to the embodiment, since the first lamp unit 22A and the second lamp unit 22B of each of the lamp modules 20L and 20R are swung together, the high-luminous-intensity region HZ can be shifted in the left-right direction according to a vehicle running state while the positional relationship between a first light distribution pattern PL1 or PR1 and a second light distribution pattern PL2 or PR2 is kept constant. This makes it possible to always cast a sufficient amount of light in a vehicle running direction.

What is more, according to the embodiment, since in each first lamp unit 22A light beams emitted from the four respective first light sources 32A arranged in the vehicle width direction are reflected toward the front side of the vehicle, a horizontally long complete first light distribution pattern PL1 or PR1 or part of it can be formed by a simple configuration.

Furthermore, since the vehicle lamp set 10 according to the embodiment is equipped with the two sets of a first lamp unit 22A and a second lamp unit 22B, by combining two sets of a first light distribution pattern PL1 or PR1 and a second light distribution pattern PL2 or PR2 formed by them, the control for improving the forward visibility of the driver of the self vehicle can be performed meticulously without causing the driver of an oncoming vehicle or a vehicle ahead to be dazzled by glare.

Although in the embodiment light-emitting diodes are used as the first light sources 32A of each first lamp unit 22A and a laser diode is used for the second light source 32B of each second lamp unit 22B, other kinds of light sources may be used.

Although in the embodiment each first lamp unit 22A is equipped with the four first light sources 32A, it may be equipped with three or less or five or more first light sources 32A.

Although in the embodiment both of the first lamp unit 22A and the second lamp unit 22B of each of the lamp modules 20L and 20R are a parabolic lamp unit, one of both of them may be another kind of lamp unit such as a projector-type lamp unit or a direct projection type lamp unit.

Although in the embodiment the pair of lamp modules 20L and 20R are disposed at the front-left and front-right corners of the vehicle, they may be dispose at different positions.

In the embodiment, the on-vehicle camera 52, the vehicle speed sensor 54, and the steer angle sensor 56 are connected to the control unit 50. Another configuration is possible in which a navigation apparatus is connected to the control unit 50 in addition to these devices and the drive controls for the swing mechanisms 26 and the turning-on/off controls for the first lamp units 22A and the second lamp units 22B are performed utilizing the navigation apparatus.

Next, a second embodiment of the present invention will be described.

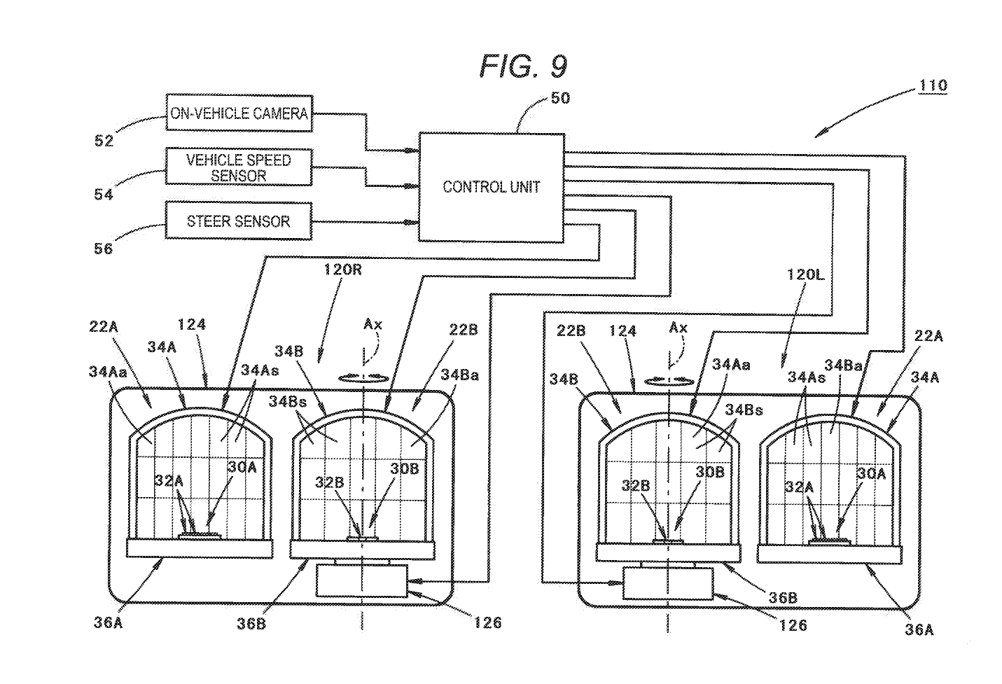

FIG. 9 is a front view of a vehicle lamp set 110 according to the second embodiment.

As seen from FIG. 9, whereas the vehicle lamp set 110 is the same in basic configuration as the vehicle lamp set 10 according to the first embodiment, the former is different from the latter in part of the configurations of lamp modules 120L and 120R.

That is, whereas the first lamp unit 22A and the second lamp unit 22B of each of the lamp modules 120L and 120R have the same configurations as those of each of the lamp modules 20L and 20R of the first embodiment, the former are different from the latter in support structure.

More specifically, in each of the lamp modules 120L and 120R, the second lamp unit 22B is supported by a support frame 124 via a swing mechanism 126 and the first lamp unit 22A is supported directly by the support frame 124. With this structure, only the second lamp unit 22B can be swung about a vertical axis Ax by the swing mechanism 126. The support frame 124 is supported by a lamp body (not shown), for example.

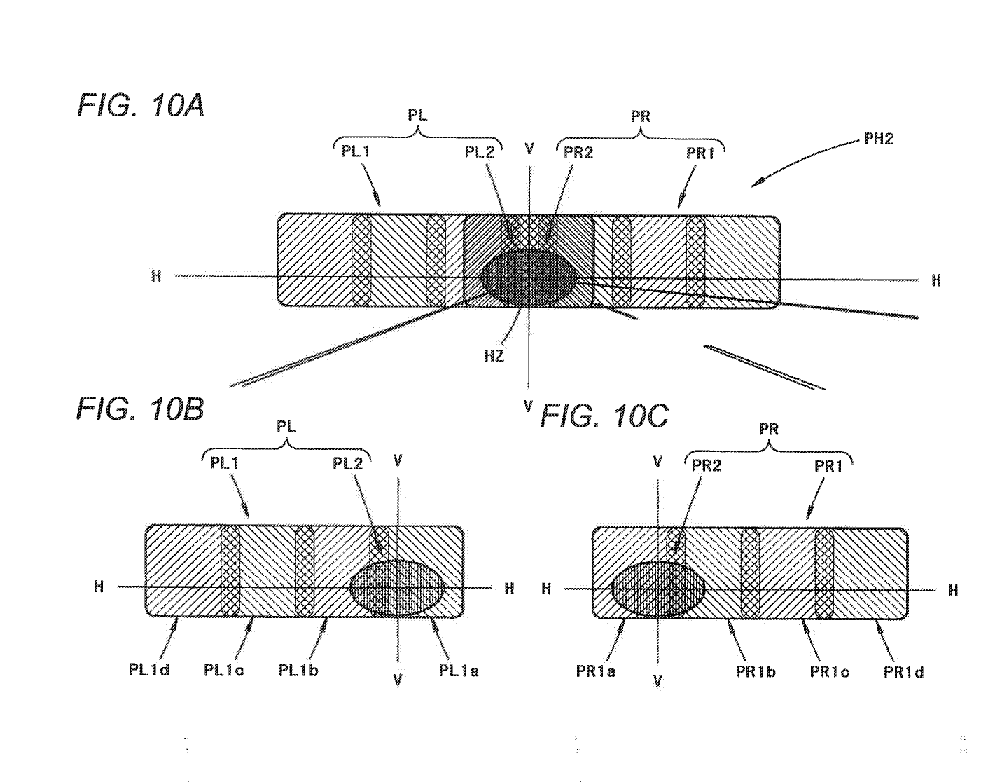

FIG. 10A is a see-through view showing a high-beam light distribution pattern PH2 which is formed by illumination light emitted from the vehicle lamp set 110 according to the embodiment.

The high-beam light distribution pattern PH2 is a light distribution pattern that is formed in a state that all of the first lamp units 22A and the second lamp units 22B of the lamp modules 120L and 120R being in the reference state are lit.

The high-beam light distribution pattern PH2 is a composite light distribution pattern of a light distribution pattern PL shown in FIG. 10B and a light distribution pattern PR shown in FIG. 10C.

The light distribution pattern PL shown in FIG. 10B is a light distribution pattern that is formed by illumination light emitted from the left lamp module 120L, and is a composite light distribution pattern of a first light distribution pattern PL1 which is formed by illumination light emitted from the first lamp unit 22A and a second light distribution pattern PL2 which is formed by illumination light emitted from the second lamp unit 22B.

The first light distribution pattern PL1 is the same as that of the first embodiment (see FIG. 3B) except that it is formed a little on the left of that of the first embodiment. The vertical line V-V intersects the rightmost light distribution pattern PL1a at a position that is a little closer to its left edge than its right edge.

The second light distribution pattern PL2 is the same as that of the first embodiment (see FIG. 3C) including the position.

The light distribution pattern PR shown in FIG. 10C is a light distribution pattern that is formed by illumination light emitted from the right lamp module 120R, and is a composite light distribution pattern of a first light distribution pattern PR1 which is formed by illumination light emitted from the first lamp unit 22A and a second light distribution pattern PR2 which is formed by illumination light emitted from the second lamp unit 22B.

The first light distribution pattern PR1 and the second light distribution pattern PR2 are left-right symmetrical with the first light distribution pattern PL1 and the second light distribution pattern PL2 with respect to the vertical line V-V in shape and luminous intensity distribution, respectively.

As shown in FIG. 10A, the high-beam light distribution pattern PH2, which is formed in such a manner that the pair of (left and right) light distribution patterns PL and PR overlap with each other and the pair of (left and right) light distribution patterns PL1a and PR1a overlap with each other, is, as a whole, a horizontally long light distribution pattern that extends leftward and rightward from the vertical line V-V.

As such, the high-beam light distribution pattern PH2 is a horizontally long light distribution pattern that extends leftward and rightward even longer distances than the high-beam light distribution pattern PH1 of the first embodiment.

Also in the high-beam light distribution pattern PH2, since the pair of (left and right) second light distribution patterns PL2 and PR2 which are small and bright occupy the same region around the point H-V, its high-luminous-intensity region HZ which is centered at the point H-V is very high in luminous intensity.

By virtue of the formation of the above-described high-beam light distribution pattern PH2, the forward visibility of the driver of the self vehicle is made sufficiently high when, for example, the vehicle is running straightly at high speed.

Furthermore, by shifting the second light distribution patterns PL2 and PR2 leftward or rightward according to a vehicle running situation, the forward visibility of the driver of the self vehicle is made sufficiently high even when, for example, the vehicle is running along a curved road.

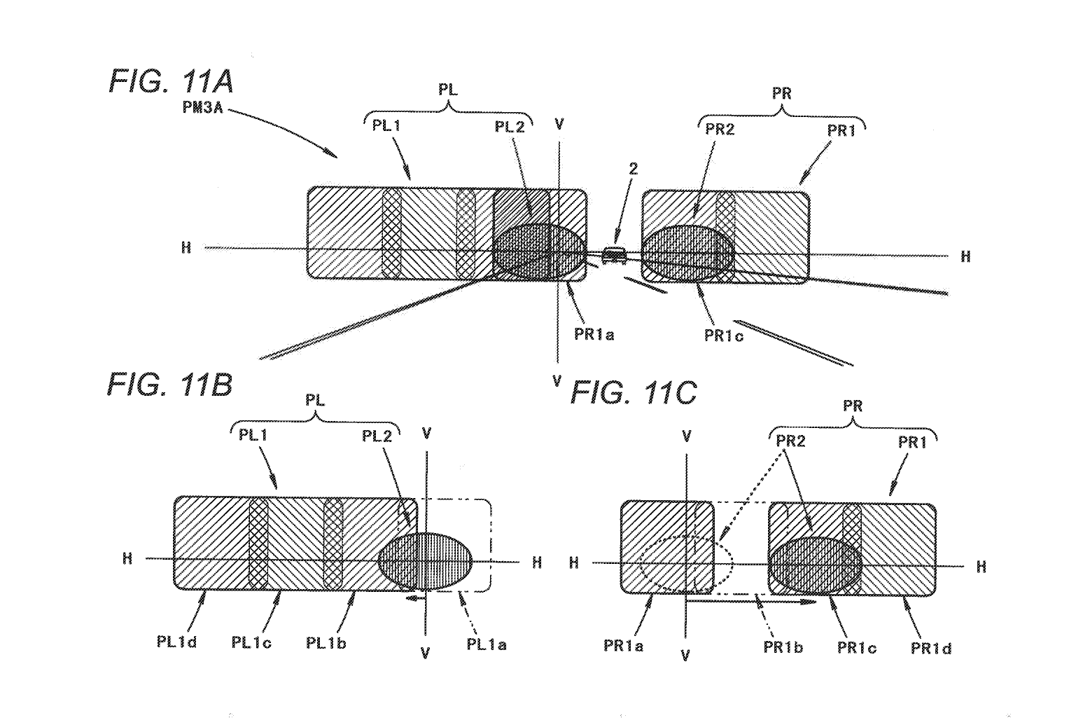

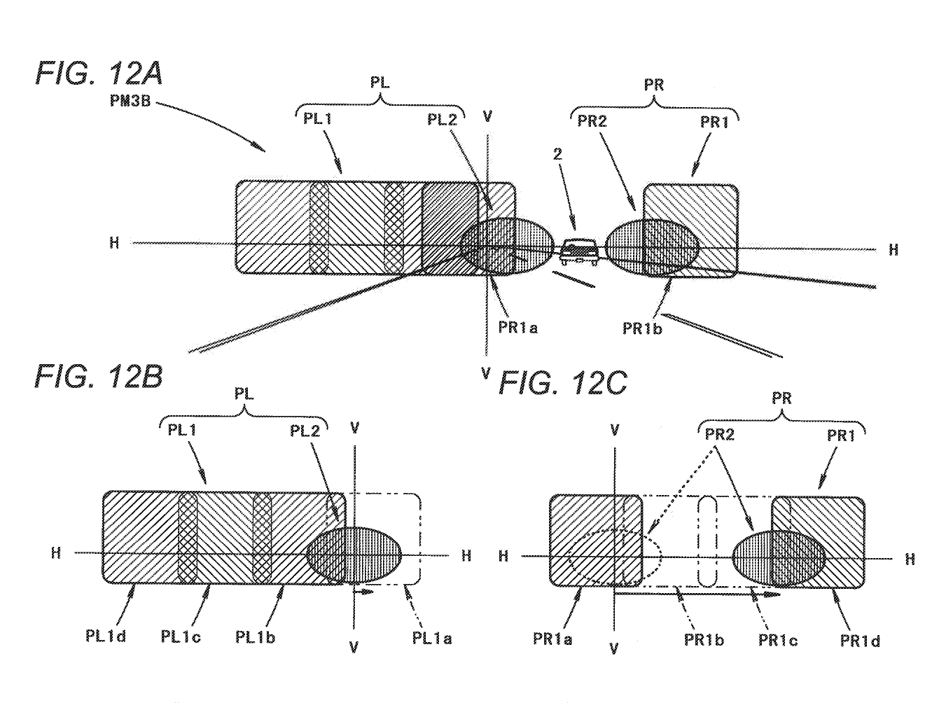

FIGS. 11A-11C and FIGS. 12A-12C show light distribution patterns each of which lacks part of the component light distribution patterns of the high-beam light distribution pattern PH2.

FIG. 11A shows a light distribution pattern PM3A which is different from the high-beam light distribution pattern PH2 shown in FIG. 10A in that the former lacks part of the first light distribution pattern PL1 of the complete left light distribution pattern PL and part of the first light distribution pattern PR1 of the complete right light distribution pattern PR, that in the former the second light distribution pattern PL2 of the left light distribution pattern PL is shifted leftward to a small extent from its position in the reference state, and that in the former the second light distribution pattern PR2 of the right light distribution pattern PR is shifted rightward to a large extent from its position in the reference state.

More specifically, the left light distribution pattern PL shown in FIG. 11B lacks the rightmost light distribution pattern PL1a of the four light distribution patterns PL1a-PL1d constituting the complete first light distribution pattern PL1. On the other hand, the right light distribution pattern PR shown in FIG. 11C lacks the second-left light distribution pattern PR1b of the four light distribution patterns PR1a-PR1d constituting the complete first light distribution pattern PR1.

In the light distribution pattern PM3A, the second light distribution pattern PL2 of the left light distribution pattern PL is shifted leftward to a small extent from its position in the reference state, whereby its right edge is made coincide with the right edge of the light distribution pattern PR1a of the first light distribution pattern PR1. And the second light distribution pattern PR2 of the right light distribution pattern PR is shifted rightward to a large extent from its position in the reference state, whereby its left edge is made coincide with the left edge of the light distribution pattern PR1c of the first light distribution pattern PR1.

With the light distribution pattern PM3A, necessary visibility can be secured for the road ahead by the combination of the second light distribution pattern PL2 and the light distribution pattern PR1a and the combination of the second light distribution pattern PR2 and the light distribution pattern PR1c, the two combinations being located on the left of and on the right of a relatively distant oncoming vehicle 2, respectively, without causing the driver of the oncoming vehicle 2 to be dazzled by glare.

Furthermore, in the light distribution pattern PM3A, the second light distribution pattern PL2 and the light distribution pattern PR1a have an overlap around the point H-V, whereby a distant road region ahead can be illuminated brightly.

Incidentally, in the embodiment, as indicated by a broken line in FIG. 11C, the second light distribution pattern PL2 of the right light distribution pattern PR is shifted from its position in the reference state to a position that is located on the right of the oncoming vehicle 2. In the embodiment, this is done in such a manner that the second light source 32B of the second lamp unit 22B of the right lamp module 120R is turned off when it is in the reference state, then the second lamp unit 22B is swung clockwise, and finally the second light source 32B is turned on again. With this measure, the light distribution pattern PM3A can be formed without causing the driver of the oncoming vehicle 2 to be dazzled by glare unintentionally.

A light distribution pattern PM3B shown in FIG. 12A is different from the light distribution pattern PM3A shown in FIG. 11A in that the former is further lacks the third-left light distribution pattern PR1c of the first light distribution pattern PR1 of the right light distribution pattern PR and the second light distribution pattern PR2 of the right light distribution pattern is shifted rightward further (see FIG. 12C).

With the light distribution pattern PM3B, even if the oncoming vehicle 2 comes even closer to the self vehicle, necessary visibility can be secured for the road ahead by the second light distribution patterns PL2 and PR2 located on the left of and on the right of the oncoming vehicle 2, respectively, without causing the driver of the oncoming vehicle 2 to be dazzled by glare.

Furthermore, also in the light distribution pattern PM3B, the second light distribution pattern PL2 and the light distribution pattern PR1a have an overlap around the point H-V, whereby a distant road region ahead can be illuminated brightly.

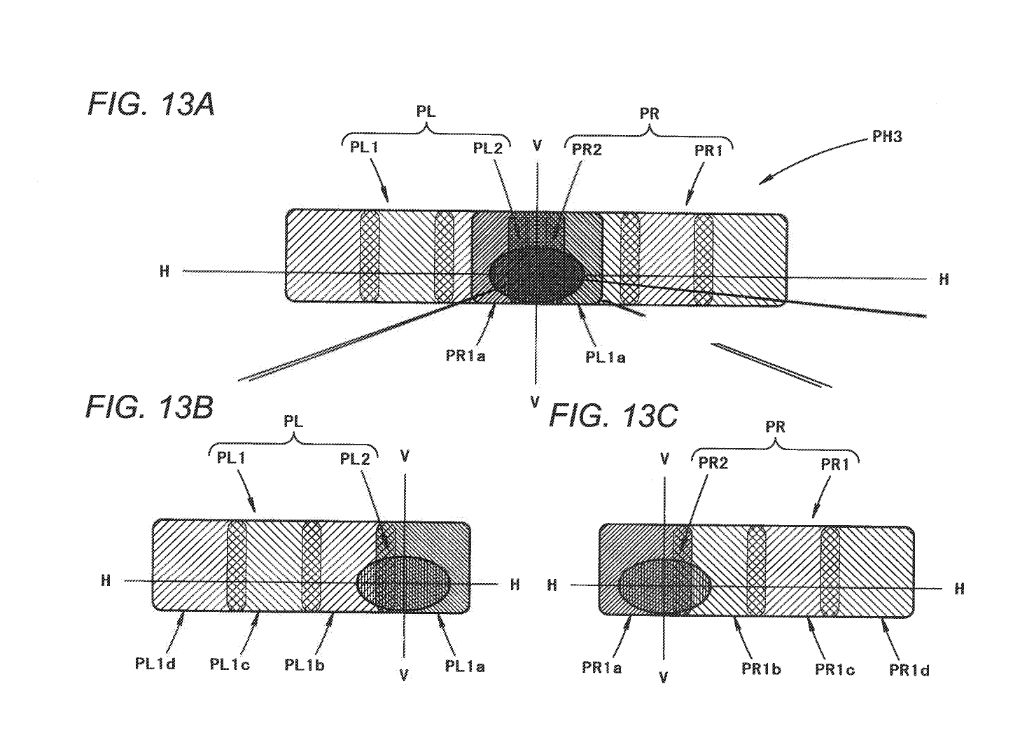

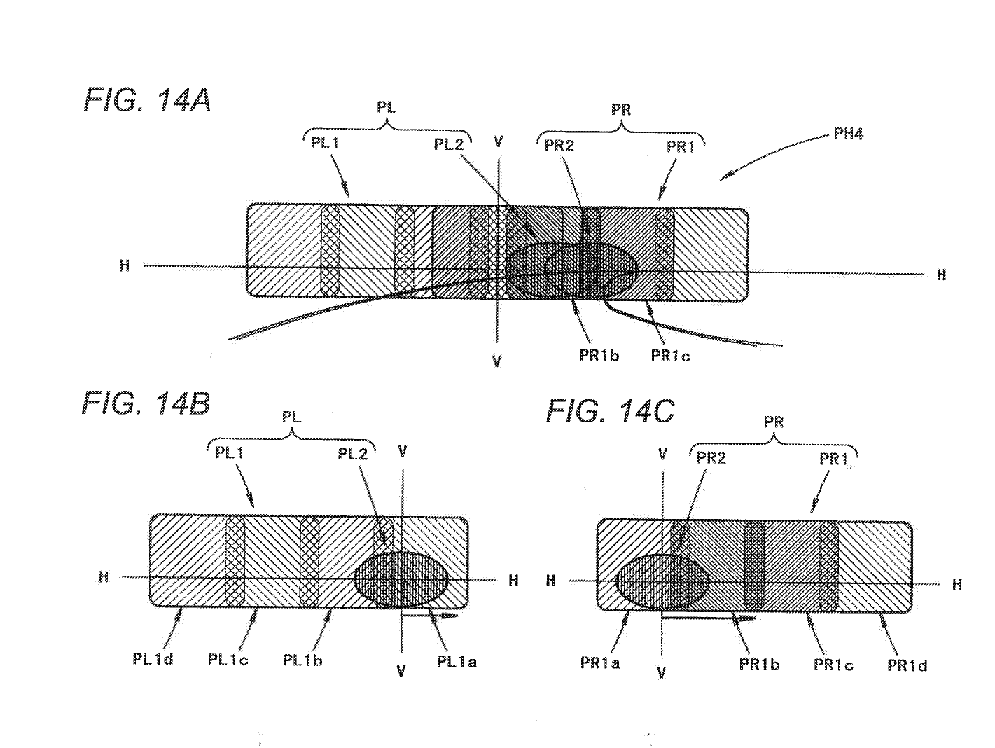

FIGS. 13A-13C and FIGS. 14A-14C show example modified high-beam light distribution patterns that are formed by illumination light emitted from the vehicle lamp 110 according to the second embodiment.

FIG. 13A shows a high-beam light distribution pattern PM3 which is different from the high-beam light distribution pattern PH2 shown in FIG. 10A in that the rightmost light distribution pattern PEA a of the first light distribution pattern PL1 of the left light distribution pattern PL and the leftmost light distribution pattern PR1a of the first light distribution Pattern PR1 of the right light distribution pattern PR (see FIGS. 13B and 13C) of the former are brighter than those of the latter.

The brighter light distribution patterns PL1a and PR1a are formed by increasing the current supplied to the first light source 32A for forming the light distribution pattern PL1a or PR1a among the four first light sources 32A of each of the lamp modules 20L and 20R.

Whereas the high-beam light distribution pattern PM3 has the same shape as the high-beam light distribution pattern PH2 shown in FIG. 10A, the former is different from the latter in that the brighter light distribution patterns PL1a and PR1a, in addition to the pair of (left and right) second light distribution patterns PL2 and PR2 which are small and bright, overlap around the point H-V. Thus, its high-luminous-intensity region HZ which is centered at the point H-V is very high in luminous intensity.

FIG. 14A shows a high-beam light distribution pattern PM4 which is different from the high-beam light distribution pattern PH2 shown in FIG. 10A in that the second light distribution patterns PL2 and PR2 of the left light distribution pattern PL and the right light distribution pattern PR of the former are shifted rightward to certain extents from their positions in the reference state (see FIGS. 14B and 14C), and that the second-left light distribution pattern PR1b and the third-left light distribution pattern PR1c of the first light distribution pattern PR1 of the right light distribution pattern PR of the former (see FIG. 14C) are brighter than those of the latter.

The distance of the rightward shift from the position in the reference state of the second light distribution pattern PR2 of the right light distribution pattern PR is a little longer than that of second light distribution pattern PL2 of the left light distribution pattern PL, whereby the two second light distribution patterns PR2 and PL2 overlap with each other being deviated from each other in the left-right direction.

With the above-described high-beam light distribution pattern PH4, sufficient visibility can be secured for the road ahead even if it is curved rightward.

Since the second light distribution patterns PR2 and PL2 overlap with each other being deviated from each other in the left-right direction, the visibility of the road ahead can be improved further.

Sufficient visibility can always be secured for the road ahead by shifting the positions of the second light distribution patterns PR2 and PL2 properly or switching the light distribution pattern(s) to be increased in brightness of the four light distribution patterns PR1a-PR1d constituting the complete first light distribution pattern PR1 of the right light distribution pattern PR according to the curvature of the road ahead.

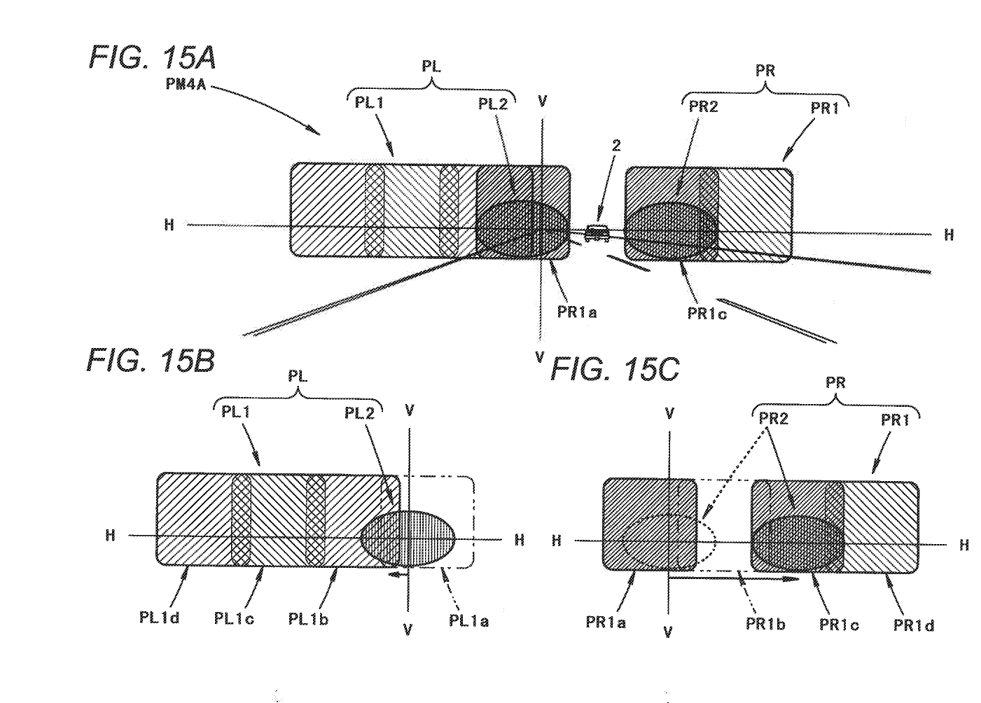

Instead of the light distribution pattern PM3A shown in FIG. 11A, a light distribution pattern PM4A shown in FIG. 15A may be formed in which the light distribution patterns PR1a and PR1c that are located on the left of and on the right of an oncoming vehicle 2, respectively, are increased in brightness (see FIG. 15C).

With the light distribution pattern PM4A, the visibility of the road ahead can be improved further without causing the driver of the oncoming vehicle 2 to be dazzled by glare.

Numerical values of particular dimensions used in the embodiments and their modifications are just examples, and it goes without saying that different values may be used instead as appropriate.

The present invention is not limited to the above embodiments and their modifications and various other modifications are possible.

1. A vehicle lamp comprising:
a first lamp unit having a plurality of first light sources; and
a second lamp unit having a second light source;
wherein the first lamp unit is configured to form a horizontally long first light distribution pattern or part of it by selectively lighting one or more of the first light sources, and the second lamp unit is configured to form a second light distribution pattern that is smaller and brighter than the first light distribution pattern by lighting the second light source, and
that at least the second lamp unit of the first lamp unit and the second lamp unit is configured so as to be able to swing in a horizontal plane.

2. The vehicle lamp according to claim 1, wherein the first light sources are light-emitting diodes and the second light sources uses a laser diode.

3. The vehicle lamp according to claim 1, wherein the first lamp unit and the second lamp unit are configured so as to be able to swing together in a horizontal plane.

4. The vehicle lamp according to claim 1, wherein
that the first lamp unit includes a reflector which reflects, toward the front side of a vehicle, light beams emitted from the first light sources; and
that the first light sources are arranged side by side in the vehicle width direction.

5. The vehicle lamp according to claim 1, wherein the vehicle lamp comprises two sets of the first lamp unit and the second lamp unit.
